(19) United States
(12) Patent Application Publication
(10) Pub. No.: US 2014/0246937 A1
(43) Pub. Date: Sep. 4, 2014

(54) ANTI-WHIRL TOUCHDOWN BEARING

(71) Applicant: LAWRENCE LIVERMORE NATIONAL SECURITY, LLC, Livermore, CA (US)

(72) Inventor: Richard F. Post, Walnut Creek, CA (US)

(73) Assignee: LAWRENCE LIVERMORE NATIONAL SECURITY, LLC, Livermore, CA (US)

(21) Appl. No.: 13/782,781

(22) Filed: Mar. 1, 2013

(51) Int. Cl. F16C 32/04

(52) U.S. Cl. CPC F16C 32/0408
USPC 310/90.5; 29/596

(57) ABSTRACT

Stabilizing techniques are provided that prevent whirl-type instabilities during the operation of magnetically levitated rotating systems. Examples include tensioned foil and tensioned wire based designs, where a restraining force arises from contact between a rotating shaft and the tensioned elements, which elements may be of either metallic or non-metallic composition. Another stabilizing technique provides a variation with azimuth in the tension of an array of foils (or wires) so as to create anisotropic stiffness for displacements that are 90° apart in azimuth. Another exemplary technique restrains displacements that have components that are transverse to (i.e., parallel with) the axis of rotation.

### STATEMENT REGARDING FEDERALLY SPONSORED RESEARCH OR DEVELOPMENT

The United States Government has rights in this invention pursuant to Contract No. DE-AC52-07NA27344 between the U.S. Department of Energy and Lawrence Livermore National Security, LLC, for the operation of Lawrence Livermore National Laboratory.

### BACKGROUND OF THE INVENTION

1. Field of the Invention

The present invention relates to magnetically levitated rotating systems, and more specifically, it relates to momentary-contact “touchdown” bearings that will restrain the rotating component from excessive displacements.

2. Description of Related Art

Magnetically levitated rotating systems, e.g., the rotors of flywheel energy storage units for stationary or vehicular use, can be subjected to acceleration loads that are too large to be restrained by the magnetic bearing system. In stationary systems these g loads would come from seismic events; in vehicular uses they would come from normal operation of the vehicle and, in the extreme, from collisions. In all such cases it is necessary to provide momentary-contact “touchdown” bearings that will restrain the rotating component from excessive displacements. However, the design of the touchdown bearing must be such that when it is in action, that is, when contact is made between the rotating element of the bearing and its stationary components, the system remains stable against rotor-dynamic “whirl” instabilities.

### SUMMARY OF THE INVENTION

This invention takes advantage of stabilizing techniques to prevent whirl-type instabilities during the operation of magnetically levitated rotating systems. One such technique employs a “foil”-based design, where a restraining force arises from contact between a rotating shaft and tensioned thin ribbons (or an array of tensioned wires) of either metallic or non-metallic composition. Another stabilizing technique provides a variation with azimuth in the tension of an array of foils (or wires) so as to create anisotropic stiffness for displacements that are 90° apart in azimuth. In still another technique, a touchdown bearing is described that restrains displacements that have components that are transverse to (i.e., parallel with) the axis of rotation. This dual-displacement function is accomplished by making the rotating contacting element conical in shape, at the same time using tensioned foils the planes of which correspond to the conical angle of the rotating part.

### BRIEF DESCRIPTION OF THE DRAWINGS

The accompanying drawings, which are incorporated into and form a part of the disclosure, illustrate embodiments of the invention and, together with the description, serve to explain the principles of the invention.

FIG. 1A is top view of a foil-based touchdown bearing.

FIG. 1B shows a cross-sectional side view of an embodiment of FIG. 1A.

FIG. 1C shows a cross-sectional view of an embodiment similar to FIG. 1A.

FIG. 2 is a schematic top view drawing of a touchdown bearing in which the tensioned elements are arrays of high-strength steel wires.

FIG. 3 shows a cross-sectional view of an embodiment that restrains displacements that have components that are transverse to the axis of rotation.

FIG. 4 shows a cross-sectional view of an embodiment that restrains displacements that have components that are transverse to the axis of rotation.

### DETAILED DESCRIPTION OF THE INVENTION

Embodiments of the present anti-whirl touchdown bearing operate without conventional lubrication and in vacuo. Thus, since the touchdown bearing may be used with rotors that are revolving at rotation rates approaching 100,000 RPM, frictional heating of the surface of the foils must be taken into account. To quantify this effect it is necessary to know the intensity and duration of the acceleration loads that are expected to be accommodated by the flywheel unit. Low acceleration levels, such as those encountered in traffic, or when traversing rough roads, can be accommodated by a combination of springs-supporting the flywheel module, together with the projected high stiffness passive magnetic bearing system of the particular flywheel to be used. High acceleration loads, such as those encountered in “fender-bender” collisions, ones in which the airbags deploy but the speeds are low, of order 15 km/hr, can be accommodated by the present touchdown bearing system. Collisions at high speed, where the vehicle is badly damaged or destroyed cannot be expected to be accommodated entirely by the touchdown bearings, and will rely on the structure surrounding the flywheel rotor to be designed to contain the rotor as it spins down, off its bearings, following the accident.

If metallic foils are used in the touchdown bearing, and if the need arises, a technique following one of the teachings of U.S. Pat. No. 5,495,221, “Dynamically Stable Magnetically Stable Suspension/Bearing System” could be employed. U.S. Pat. No. 5,495,221 is incorporated herein by reference. Specifically, if the rotating shaft contains embedded permanent magnetic material positioned so as to create an array of narrow-gap magnetic poles, when the rotating shaft approaches a metallic ribbon foil, localized eddy currents will be set up in the ribbon that will create a repulsive force. If this force is strong enough, the touchdown action can be accomplished without frictional contact between the ribbon foil and the shaft. Because of the narrowness of the magnetic gaps, the magnetic field will decrease rapidly with distance from the gap. Thus there should be minimal eddy currents generated in the foils when the shaft is centered, at which point the distance between the magnetic gap and the foil has its largest value.

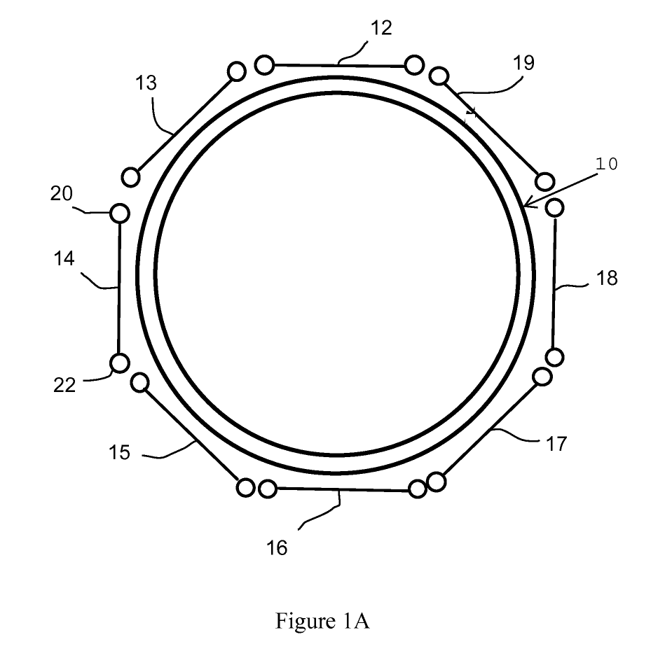

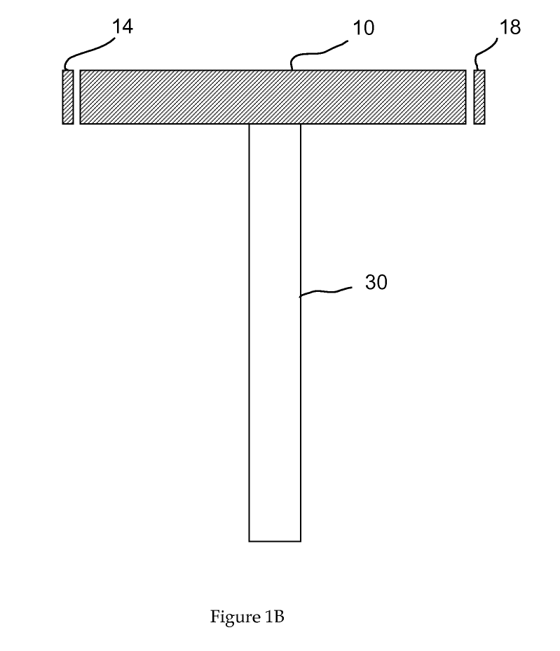

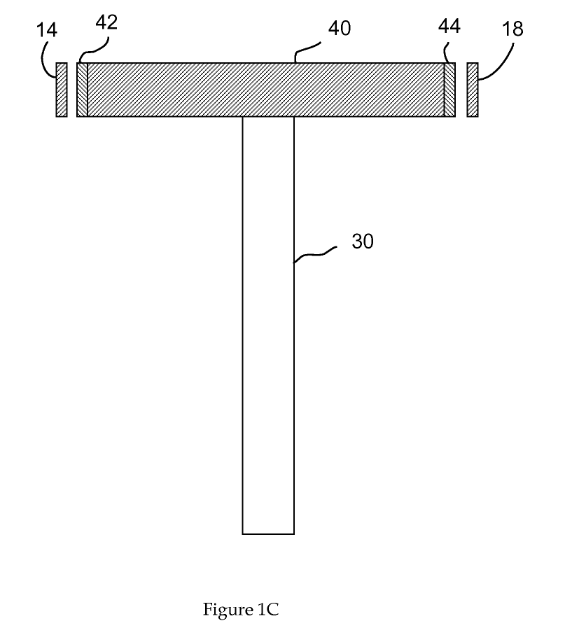

FIG. 1A is top view of a foil-based touchdown bearing. The figure shows a rotatable cylinder 10 surrounded by foils 12-19. The rotatable cylinder may be the rotor of a magnetically levitated flywheel energy storage system as known in the art. It may also be the shaft that supports the rotor. The cylinder may also be replaced with a solid disc. Alternates will be apparent to those skilled in the art based on the teachings herein. In this exemplary embodiment, each foil is supported by a foil support and tensioner pair. For example, foil 14 is supported by foil support and tensioners 20 and 22. The support and tensioner simply function to hold the foil and to induce a desired tension. For example, a rotatable rod or screw functioning as tensioner 20 is fixedly attached to an end of foil 14. The rotatable rod or screw is located within a fixed body that axially holds the tensioner in place, while allowing the tensioner to rotate about its axis. When tensioner 20 is rotated in one direction, the foil tension is increase when tensioner 20 is rotated in the opposite direction, the foil tension is decreased. A rotatable solid disc can be substituted for rotatable cylinder 10. While under rotation, if the cylinder moves from its centered position and comes in contact with one or more of foils 12-19, a re-centering force will be exerted upon the cylinder.

FIG. 1B shows a cross-sectional side view of an embodiment of FIG. 1A. The figure shows the rotatable cylinder 10 and foils 14 and 18. A rotatable shaft 30 is fixedly attached to the rotatable cylinder 10. FIG. 1C shows a cross-sectional view of an embodiment similar to FIG. 1A. In this embodiment, periodically spaced permanent magnets are affixed to the cylinder. Although the magnets are periodically spaced all the way around the cylinder, since the figure is a cross-sectional view, it only shows two of these magnets. Accordingly, the figure shows a rotatable cylinder 40 with permanent magnets 42 and 44 located around its perimeter. The figure includes a similar foil and foil support and tensioner system and rotatable shaft as described in FIGS. 1A and 1B, and therefore uses the same reference numbers. When the rotating cylinder encounters whirl instability, the gap between the cylinder and the foils will decrease at some point, wherein the magnets will induce eddy currents in the foil and exert a repelling force, thereby centering the rotor.

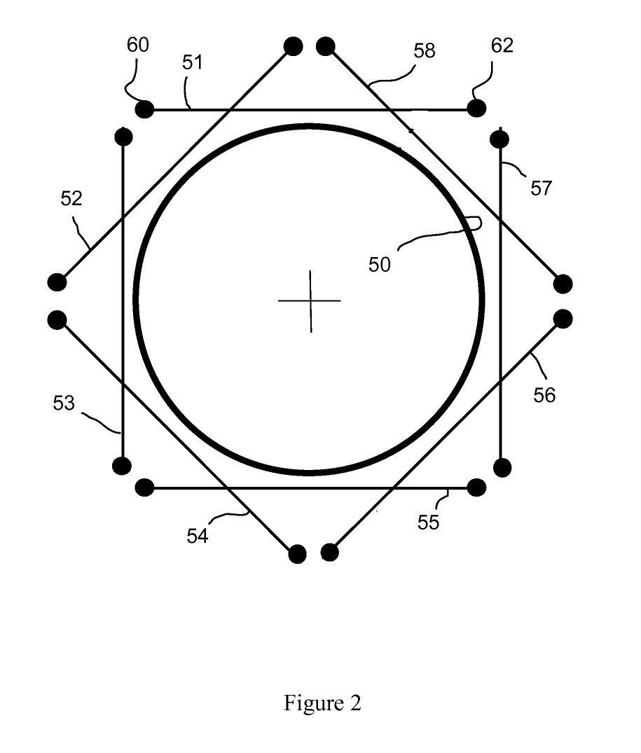

FIG. 2 is a schematic top view drawing of a touchdown bearing in which the tensioned elements are arrays of high-strength steel wires. The figure shows the rotor 50 contact surface and tensioned wire arrays 51-58. Each tensioned wire is supported at each end by a wire tensioning element. For example, wire 51 is supported by wire tensioning elements 60 and 62. The wire array based touchdown bearing can include a shaft as in FIG. 1B. The rotor 50 can include the permanent magnet configuration of FIG. 1C, in which case, the magnets will induce eddy currents in the tensioned wires if the rotor encounters whirl instability. As can be seen from the drawing the use of arrays of tensioned wires allows one to increase the distance between the tensioning supports by interleaving the wire arrays. It thus also allows the generation of a continuous polygonal contact surface for the stationary element of the touchdown bearing.

Note that by providing a variation with azimuth in the tension of the array of foils of FIGS. 1A-1C or of the wires of FIG. 2, an anisotropic stiffness is created for displacements that are 90° apart in azimuth. This produces a centering effect against whirl type instabilities.

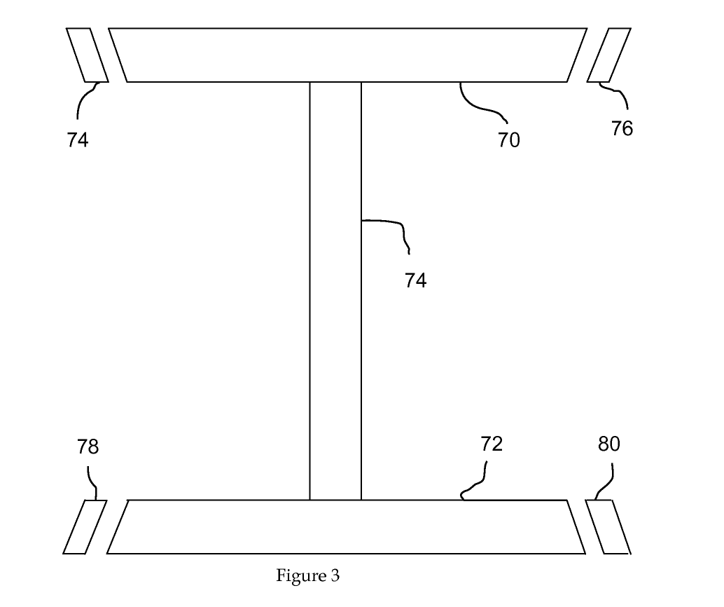

FIG. 3 shows a cross-sectional view of an embodiment that can be combined with the embodiments described herein. This embodiment restrains displacements that have components that are transverse to (i.e., parallel with) the axis of rotation. This dual-displacement function is accomplished by making the rotating contacting element conical in shape, at the same time using tensioned foils or wires, the planes of which correspond to the conical angle of the rotating part. The conical rotor 70 and oppositely directed conical rotor by 72 are attached by shaft 74. Since the figure is a cross-sectional view, it only shows foils 74 and 76 beside rotor 70; however, additional foils are spaced around the rotor, e.g., as in FIG. 1A. Likewise, although the figure only shows foils 78 and 80 beside rotor 72, the foils are spaced around the rotor. As in the embodiments above, wires can be substituted for the foils. A permanent magnet configuration similar to FIG. 1C can also be employed. Thus, for those cases where the touchdown bearings must resist accelerations that are both transverse to and parallel to the axis of rotation of the flywheel, the tensioned foils or wire arrays could be oriented so as to constrain the motion of a conical rotating touchdown surface. As in the previous cases, the foil or wire-array tensions would be varied with azimuthal location, so as to suppress such whirl instabilities. Rotor 72 and foils 78 and 80 may be omitted in some embodiments, e.g., in a vertically oriented system.

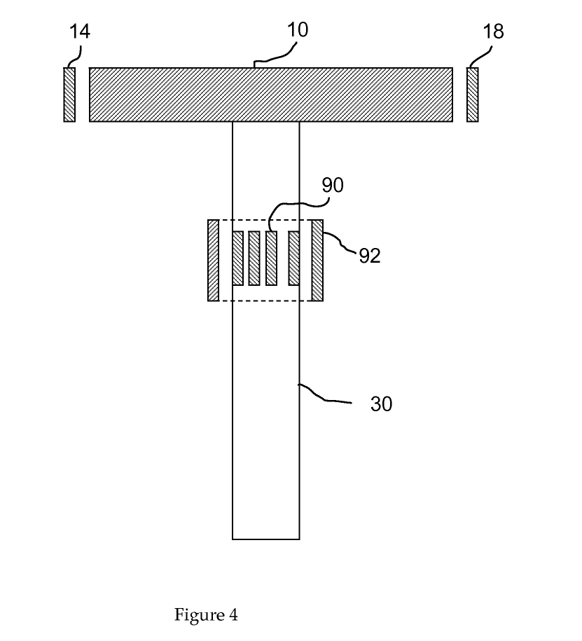

FIG. 4 shows a cross-sectional view of an embodiment that is similar to the one of FIG. 1B but that further restrains displacements that have components that are transverse to (i.e., parallel with) the axis of rotation. As in FIG. 1B, it includes a rotor 10, foils 14 and 18 and shaft 30. As in the embodiment of FIG. 1B, it further includes foils spaced around the perimeter of the rotor. The figure shows an array of narrow gap, spaced permanent magnets around the shaft. Magnet 90 is one of the magnet elements. A fixed position metallic sleeve 92 is located around the shaft over the location of the permanent magnets such that if the shaft moves in direction transverse to the axis of rotation, eddy currents will be induced in the metallic sleeve which will produce a centering effect on the shaft. Note that the metallic sleeve can be replaced with wires.

The foregoing description of the invention has been presented for purposes of illustration and description and is not intended to be exhaustive or to limit the invention to the precise form disclosed. Many modifications and variations are possible in light of the above teaching. The embodiments disclosed were meant only to explain the principles of the invention and its practical application to thereby enable others skilled in the art to best use the invention in various embodiments and with various modifications suited to the particular use contemplated. The scope of the invention is to be defined by the following claims.

I claim:

1. An apparatus, comprising:
a rotor; and
an anti-whirl touchdown bearing configured to prevent whirl-type instabilities in said rotor during rotation of said rotor.

2. The apparatus of claim 1, wherein said rotor is a rotor of a magnetically levitated rotating system.

3. The apparatus of claim 2, wherein said bearing comprises a series of foils located around the perimeter of said rotor.

4. The apparatus of claim 3, wherein each foil of said series of foils is placed at a gap from said perimeter.

5. The apparatus of claim 4, wherein said each foil is positioned such that it is parallel with a line drawn bisecting the cylinder through its central axis.

6. The apparatus of claim 5, wherein said each foil is positioned to be tangent to said perimeter.

7. The apparatus of claim 6, further comprising means for changing the tension of each said foil.

8. The apparatus of claim 7, wherein each said foil comprises metal.

9. The apparatus of claim 8, further comprising a series of permanent magnets fixedly attached to said perimeter.

10. The apparatus of claim 1, wherein said rotor comprises a first tapered perimeter and wherein said bearing is angled to match the taper of said first tapered perimeter.

11. The apparatus of claim 10, further comprising a second rotor having a second tapered perimeter tapered in the opposite direction as that of said first tapered perimeter.

12. The apparatus of claim 1, wherein said rotor comprises shape selected from the group consisting of a cylinder, a disc and a shaft.

13. The apparatus of claim 12, wherein said shaft comprises periodically spaced permanent magnet material, the apparatus further comprising a fixed metallic sleeve located around the said outside of said periodically spaced permanent magnet material.

14. The apparatus of claim 2, wherein said bearing comprises a series of wires located around the perimeter of said rotor.

15. The apparatus of claim 14, wherein each wire of said series of wires is placed at a gap from said perimeter.

16. The apparatus of claim 15, wherein said each wire is positioned such that it is parallel with a line drawn bisecting the cylinder through its central axis.

17. The apparatus of claim 16, wherein said each wire is positioned to be tangent to said perimeter.

18. The apparatus of claim 17, further comprising means for changing the tension of each said wire.

19. The apparatus of claim 18, wherein each said foil comprises metal.

20. The apparatus of claim 19, further comprising a series of permanent magnets fixedly attached to said perimeter.

21. The apparatus of claim 2, wherein said bearing comprises a series elements selected from the group consisting of (i) a series of foils located around the perimeter of said rotor and (ii) a series of wires located around the perimeter of said rotor, wherein said series of elements are configured to provide a variation with azimuth in the tension of said series of elements so as to create anisotropic stiffness for displacements that are 90° apart in azimuth.

22. The apparatus of claim 2, wherein said bearing comprises a series elements selected from the group consisting of (i) a series of foils located around the perimeter of said rotor and (ii) a series of wires located around the perimeter of said rotor, wherein said series of elements are configured such that elements located 90° apart in azimuth have a different relative tension one-to-another to provide a variation with azimuth in the tension of said series of elements so as to create anisotropic stiffness for displacements that are 90° apart in azimuth.

23. A method for preventing or ameliorating whirl-type instabilities in the rotor of a magnetically levitated rotating system, the method comprising:
providing an anti-whirl touchdown bearing configured to prevent whirl-type instabilities in said rotor during rotation of said rotor
rotating said rotor about its central axis; and
providing a centering force upon said rotor from said bearing when said rotor experience whirl-type instabilities, wherein said bearing comprises a series of elements selected from the group consisting of (i) a series of foils located around the perimeter of said rotor and (ii) a series of wires located around the perimeter of said rotor.

24. The method of claim 23, wherein each foil of said series of foils and each wire of said series of wires is placed at a gap from the perimeter of said rotor, is positioned such that it is parallel with a line drawn bisecting said rotor through said central axis and is tangent to said perimeter.

25. The method of claim 24, wherein said rotor comprises shape selected from the group consisting of a cylinder, a disc and a shaft.

26. The method of claim 25, wherein said rotor comprises periodically spaced permanent magnet material fixed to the perimeter of said rotor.

27. The method of claim 26, wherein said series of elements comprises metal, wherein when said gap narrows upon whirl-type instabilities, eddy currents will be generated in one or more elements of said series of elements, thereby producing a repelling force to induce said centering force.

28. The method of claim 24, wherein said rotor is fixedly attached to a shaft rotatable within a relatively fixed metallic sleeve, wherein said shaft comprises periodically spaced permanent magnet material.

29. The method of claim 28, wherein when said gap narrows upon whirl-type instabilities, eddy currents will be generated in said relatively fixed metallic sleeve, thereby producing a repelling force.

30. The method of claim 23, wherein said series of elements are configured such that elements located 90° apart in azimuth have a different relative tension one-to-another to provide a variation with azimuth in the tension of said series of elements so as to create anisotropic stiffness for displacements that are 90° apart in azimuth.
